(19) United States
(12) Patent Application Publication
(10) Pub. No.: US 2013/0287243 A1
(43) Pub. Date: Oct. 31, 2013

(54) ELECTRONIC DEVICE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: XUE-FENG WAN, Shenzhen (CN); PING LI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/706,421

(22) Filed: Dec. 6, 2012

(30) Foreign Application Priority Data
Apr. 27, 2012 (CN) 201210127472.4

(51) Int. Cl. H04R 1/02

(52) U.S. Cl. CPC H04R 1/025
USPC 381/395

(57) ABSTRACT

An electronic device includes a housing, a speaker, a securing board, and at least one guiding board. The securing board defines an opening to allow the speaker to be exposed outside the securing board. The securing board includes a first side and a second side opposite to the first side. During assembly the securing board to the housing, the guiding board enables the first side to be supported by the guiding board, and the second side rotates towards the speaker around the first side.

### BACKGROUND

1. Technical Field

The present disclosure relates to fastening structures, particularly to an electronic device and fastening structures for fastening a speaker.

2. Description of Related Art

Most speakers are located inside of the housing of an electronic device. The speaker is secured to the housing by a fastening structure. The typical fastening structure includes a guiding post and a metal cover. The guiding post perpendicularly protrudes from the housing, and the guiding post is adjacent to the speaker. The cover defines a guiding hole corresponding to the guiding post, and an opening. The opening is aligned with the speaker to disable the magnet to attract the metal after the guiding post is passed through the guiding hole. Then the cover covers and is secured to the housing via a screw. Because the metal cover is near to the magnet in the speaker, this degrades the effectiveness of the speaker. The guiding post needs to be long enough to enable the opening to be aligned with the speaker when the cover is away from the speaker. However, making the guiding posts longer affect the microminiaturization of the electronic device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an electronic device having a fastening board.

FIG. 2 is an exploded view of the electronic device in FIG. 1.

FIG. 3 is an isometric view of the fastening board in FIG. 1, viewed from another aspect.

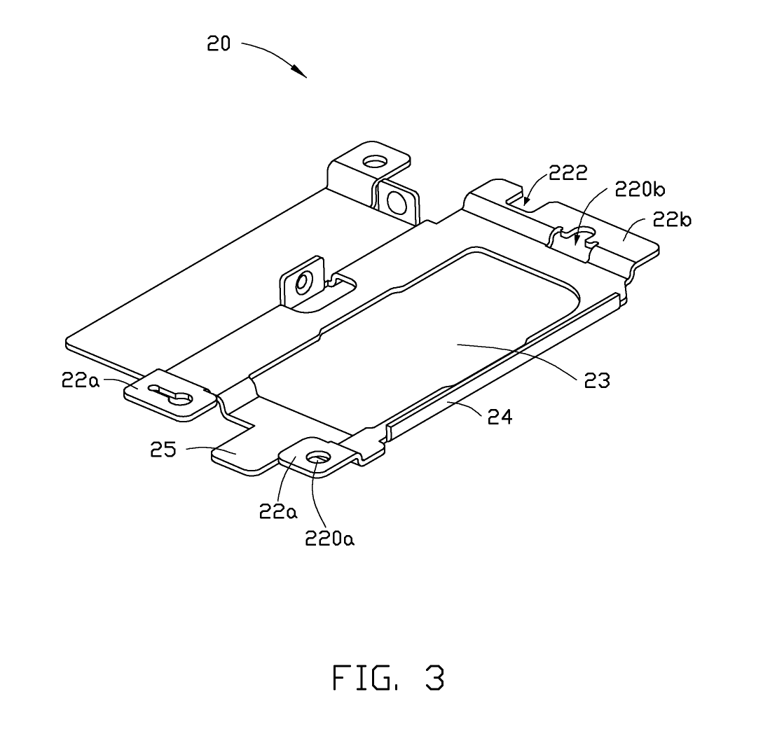

### DETAILED DESCRIPTION

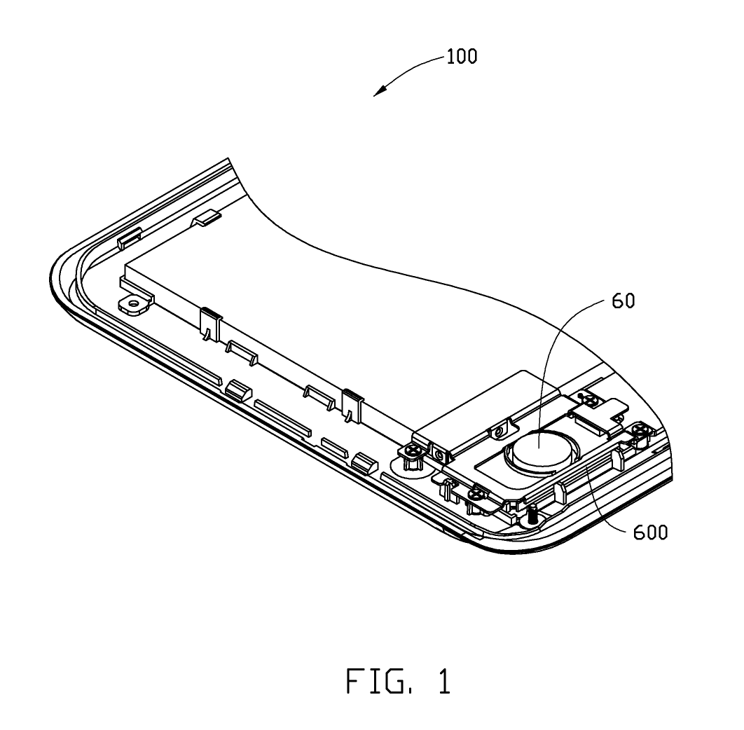

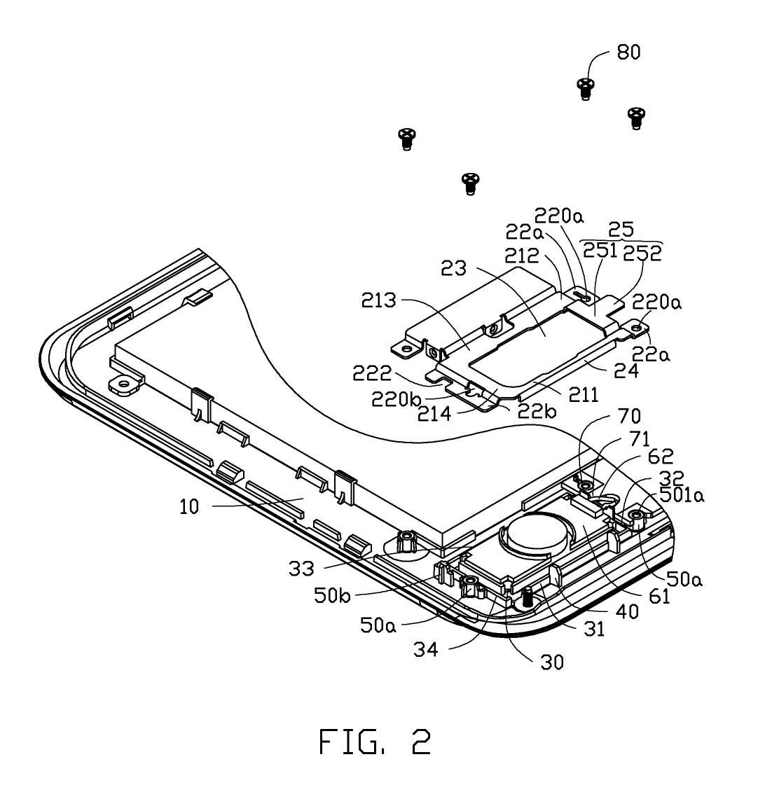

Referring to FIGS. 1 and 2, an electronic device 100 in accordance with an embodiment is shown. The electronic device 100 includes a fastening structure 600 for securing a speaker 60 inside of the electronic device 100. A speaker cable 62 extends from the speaker 60.

The fastening structure 600 includes a housing 10, a securing board 20, a receiving part 30, two guiding bar 40, a plurality of first fastening parts 50a, a second fastening part 50b, and a plurality of screws 80. The speaker 60 is received in the receiving part 30. The securing board 20 covers the receiving part 30 to secure to the speaker 60. The two guiding bars 40 guide the securing board 20 to secure to the speaker 60. The plurality of screws 80 pass through the securing board 20 and are fastened to the first fastening part 50a. The second fastening 50b passes through the securing board 20.

The receiving part 30 is adjacent to one side of the housing 10. The receiving part 30 includes a first sidewall 31, a second sidewall 33, a third side wall 32, and a fourth sidewall 34. The first sidewall 31 is parallel to the second sidewall 33. The third sidewall 33 is parallel to the fourth sidewall 34. The first, the second, the third, and the fourth sidewalls 31, 33, 32, and 34 are connected end-to-end to form a receiving space to receive the speaker 60. The first sidewall 31 is adjacent to one side of the housing 10. From one end of the third sidewall 32 away from the housing 10 projects a supporting board 70. One end of the supporting board 70 away from the housing 10 defines a first gap 71. The first gap 71 allows the speaker cable 62 to pass through the supporting board 70.

The number of the first fastening parts 50a is three. Two of the first fastening parts 50a are located outside of the third sidewall, and adjacent to opposite ends of the third sidewall 32. The other one of the first fastening part 50a is adjacent to the fourth sidewall 34, and corresponds to the middle of the fourth sidewall 34. Each fastening part 50a defines a first fixing hole 501. The second fastening part 50b is adjacent to the fourth sidewall 34 and located at one end of the fourth sidewall 34 away from the first sidewall 31.

The guiding boards 41 are rectangular bars perpendicularly protruding from the housing 10. The guiding boards 40 are located outside of the receiving part 30 at intervals and connected to the first sidewall 31. The height of the guiding board 40 is higher than the height of the receiving part 30 taken along a direction perpendicular to the housing 10. When the speaker 60 is received in the receiving part 30, the end of the guiding board 40 away from the housing 10 is coplanar with the end of the speaker 60 away from the housing 10.

The securing board 20 includes a base 21, an opening 23 defined in the base 21, a blocking board 24, a pressing arm 25, two first mounting part 22a, and a second mounting part 22b. The base 21 is rectangular, the base 21 includes a first side 211, a second side 212, and a third side 214. The first side 211 is opposite to the second side 212. The third side 212 is connected between the first side 211 and the second side 214. The first, the second, and the third sides 211, 212, and 214 cooperatively form the opening 23.

The blocking board 24 is a rib perpendicularly extending downward from the first side 211. The pressing arm 25 spans between the first side 211 and the second side 213, and the pressing arm 25 is opposite to the third side 214. The pressing arm 25 includes a connecting part 251, and a pressing part 252. The connecting part 251 arches from the base 251 and is connected between the first side 211 and the second side 213. The pressing part 252 horizontally extends from the connecting part 251 and is away from the third side 214.

The first mounting parts 22a are positioned at two opposite sides of the pressing part 252. The first mounting parts 22a extend downwardly and horizontally from the base 21. Each first mounting part 22a defines a second fixing hole 220a.

The second mounting part 22b extends downwardly and horizontally from the third side 214. The second mounting part 22b defines a second gap 222. The gap 222 is away from the first side 221. The second mounting part 22b defines a third fixing hole 220b.

Referring to FIG. 1 again, the assembly of the electronic device 100 is described as below. First, the speaker 60 is placed into the receiving part 30, and the speaker 60 contact the second sidewall 33, the third sidewall 32, and the fourth sidewall 34; there is a space between the first sidewall 31 and the speaker 60; the speaker cable 62 passes through the supporting board 70 via the first gap 71. Second, the first side 211 of the securing board 20 faces the speaker 60, the second side 213 is away from the speaker 60. Third, the securing board 20 is moved to the speaker 60 to enable the blocking board 24 to be positioned between the first side 211 and the guiding boards 40, and blocked by the guiding boards 40. Fourth, the second side 213 is rotated around the first side 211 to contact the speaker 60. At this time, the speaker 60 is exposed outside of the securing board 20 via the opening 23. The first fixing holes 501 of two of the first fastening parts 50 are concentric with the second fixing hole 220a of the first mounting part 22a. The first fixing hole 501 of the other one of the fastening parts 50 is concentric with third fixing hole 220b of the second mounting part 22b. The second fastening part 50b passes through the second gap 222, the pressing arm 25 presses on the supporting board 70. Fifth, the screws 80 respectively pass through the first fixing holes 220a and the second fixing hole 220b to screw in the first fixing holes 501 of the first fastening parts 50a. As a result, the securing board 20 tightly presses on the speaker 60, the pressing arm 25 tightly presses on the supporting board 70 to cover the speaker cable 62.

The electronic device 100 and the fastening structure 600 for fastening the speaker 60 as described above includes the guiding boards 40. One side of the securing board 20 is blocked by the guiding boards 40, the other side of the securing board 20 is away from the speaker 60, and the other side of the securing board 20 is rotated around the side of securing board 20 blocked by the guiding boards 40 during assembly of the securing board 20 to the housing 10. Therefore, the magnetism of the speaker 60 is reduced during the securing board 20 assembly to the housing 10, and the guiding board 40 need not be long to enable the securing board 20 to be away from the speaker 60. Therefore, the guiding boards 40 do not affect the microminiaturization of the electronic device 100.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a housing;
a speaker;
a securing board assembled to the housing, the securing board defining an opening to allow the speaker to be exposed outside of the securing board, the securing board comprising a first side and a second side opposite to the first side; and
a guiding board protruding from the housing;
wherein during assembly of the securing board to the housing, the first side of the securing board resists the guide board, the second side of the securing board rotates towards the speaker around the first side to enable the securing board to cover the speaker.

2. The electronic device of claim 1, wherein a blocking board perpendicularly protrudes from the first side of the securing board, the guiding board supports the blocking board.

3. The electronic device of claim 1, wherein one end of the guiding board away from the housing is coplanar with one end of the speaker away from the housing.

4. The electronic device of claim 1, wherein the securing board comprises a pressing arm connected between the first side and the second side to press the speaker cable extending from the speaker.

5. The electronic device of claim 1, wherein the number of the guiding board is two, the guiding boards locate at interval.

6. The electronic device of claim 1, further comprising a receiving part protruding from the housing to receive the speaker.

7. An electronic device, comprising:
a housing;
a speaker;
a securing board assembled to the housing, the securing board defining an opening to allow the speaker to be exposed outside the securing board, the securing board comprising a first side and a second side opposite to the first side; and
at least one guiding board protruding from the housing;
wherein during assembly of the securing board to the housing, the first side is supported by the guiding part and contact the speaker, the second side is moved down to contact the speaker from a position away from the speaker.

8. The electronic device of claim 7, wherein a blocking board perpendicularly protrudes from the first side of the securing board, the guiding board supports the blocking board.

9. The electronic device of claim 7, wherein one end of the guiding board away from the housing is coplanar with one end of the speaker away from the housing.

10. The electronic device of claim 7, wherein the securing board comprises a pressing arm connected between the first side and the second side to press the speaker cable extending from the speaker.

11. The electronic device of claim 7, wherein the number of the guiding board is two, the guiding boards at locate at interval.

12. The electronic device of claim 7, further comprising a receiving part protruding from the housing to receive the speaker.
